(19) United States
(12) Patent Application Publication
(10) Pub. No.: US 2021/0404966 A1
(43) Pub. Date: Dec. 30, 2021

(54) RAMAN SPECTROSCOPIC METHODS AND USE FOR DETECTION OF BIOLOGICAL THREATS

(71) Applicant: Arizona Board of Regents on Behalf of Northern Arizona University, Flagstaff, AZ (US)

(72) Inventors: Miguel Jose Yacaman, Flagstaff, AZ (US); Paul S. Keim, Flagstaff, ZA (US); Andrew T. Koppisch, Flagstaff, AZ (US); Robert Keller, Flagstaff, AZ (US); David M. Wagner, Flagstaff, AZ (US); Jason Sahl, Flagstaff, AZ (US)

(21) Appl. No.: 17/223,367

(22) Filed: Apr. 6, 2021

Related U.S. Application Data
(60) Provisional application No. 63/006,618, filed on Apr. 7, 2020.
(60) Provisional application No. 63/079,653, filed on Sep. 17, 2020.
(60) Provisional application No. 63/047,452, filed on Jul. 2, 2020.

(51) Int. Cl. G01N 21/65

(52) U.S. Cl. CPC G01N 21/658

(57) ABSTRACT

The present disclosure describes a novel system and method for providing a fast, inexpensive and reliable diagnostic test for indicating the presence of a biological threat. This test utilizes surface-enhanced Raman spectroscopy to interrogate a sample comprising metallic plasmonic particles suspected of contamination with the biological threat. The Raman spectrum is analyzed for specific Raman shifts that are characteristic of an interaction of the biological threat with the metallic plasmonic particles to produce a diagnostic result.

### CROSS REFERENCE TO RELATED APPLICATIONS AND PUBLICATIONS

This application claims the benefit under 35 U.S.C. § 120 of each of U.S. Prov. App. Nos. 63/006,618 filed on Apr. 7, 2020; 63/079,653 filed on Sep. 17, 2020; and 63/047,452 filed on Jul. 2, 2020. Each of the foregoing priority applications are hereby incorporated by reference in their entireties.

### BACKGROUND

One of the most pressing problems for bioterrorism and pandemics is accurately detecting the presence of the biological threat. For example, the primary method to testing for SARS-CoV-2 has been the reverse transcriptase-polymerase chain reaction (RT-qPCR) from pharyngeal or nasal swabs. Recent research has suggested that the sensitivity of RT-PCR (i.e., the percentage of infected people who are correctly identified as having the condition) is 62% for nasal and 32% for pharyngeal. Although this study requires expansion to a larger sample set, the findings are very troublesome. Furthermore, this RT-PCR test requires the use of fluorescent DNA probes and PCR reagents which have been in short supply with additional complications relating to false negatives. Processing specimens requires a high complexity laboratory and results are available only after hours or days from the sample collection. Accurate and rapid testing is essential for public policy and work management decisions.

Surface-enhanced Raman spectroscopy (SERS) can generate specific signatures that can be used to rapidly detect the presence of an analyte and is very effective in sensing small amounts of analyte when the analyte interacts with a metallic surface. Although the method is fast, inexpensive, and can be deployed in the field, its widespread utility has been hampered by several problems. Specifically, weak, low intensity signals hinder accurate detection in samples such as aerosols; additionally, the fluorescence effect in biomolecules that introduces noise on the Raman spectra. Performing Raman spectroscopy on virion particles is complicated by the numerous molecular vibrations of the multiple macromolecules that result in many closely spaced Raman signals and broad peaks of overlapping signals. One example is the spectra of HIV-1 virus as reported by Lee et al; Development of a HIV-1 Virus Detection System Based on Nanotechnology. Sensors, 2015, 15(5). A recent study of SARS-CoV-2 with SERS used a silver-nanorod SERS array functionalized with cellular receptor angiotensin-converting enzyme 2 (ACE-2) as reported by Zhang et al; Rapid One-Pot Detection of SARS-CoV-2 Based on a Lateral Flow Assay in Clinical Samples. Analytical Chemistry, 2021. The Raman peak for ACE-2 at 1189 cm⁻¹ was shifted 1182 cm⁻¹ when the SARS-CoV-2 spike protein was attached. In theory, the ratio of intensity of the two peaks could report a presence of the virus but the spectra displayed few peaks that were all low intensity. Another recent study reported Raman spectroscopy of an RNA virus in saliva using a lentivirus vector system based on HIV-1 as reported by Desai et al; Raman spectroscopy-based detection of RNA viruses in saliva: A preliminary report.” Journal of BioPhotonics, 2020, 13. The spectra that were obtained displayed few peaks.

Therefore, there is a clear need in the field to develop a SERS method that is capable of overcoming its present shortcomings for use as an accurate and efficient mode of detection for biological threats including SARS-CoV-2.

### SUMMARY

Several embodiments of the present disclosure relate to a diagnostic test to determine the presence of a biological threat. In several embodiments, the diagnostic test includes a substrate that includes one or more plasmonic particles. In several embodiments, the diagnostic test includes a surface-enhanced Raman spectrometer. In several embodiments, the plasmonic particles of the diagnostic test include a metal selected from the group consisting of copper, silver, gold, and a combination thereof. In several embodiments, the substrate comprises molybdenum disulfide. In several embodiments, the biological threat is a virus or a bacterial strain. In several embodiments, the biological threat is a coronavirus. In several embodiments, the biological threat is SARS-CoV-2. In several embodiments, the biological threat includes a biological weapon of mass destruction. In several embodiments, the biological weapon of mass destruction is an aerosol.

Several embodiments of the present disclosure relate to a method to detect a biological threat. In several embodiments, the method includes obtaining a sample suspected of comprising the biological threat. In several embodiments, the sample includes one or more plasmonic particles. In several embodiments, the method includes applying Raman spectroscopy on the sample to produce a Raman spectrum. In several embodiments, the method includes analyzing the Raman spectrum for one or more signature Raman shifts characteristic of an interaction of the plasmonic particles with the biological threat. In several embodiments, the biological threat is a virus or a bacterial strain. In several embodiments, the biological threat is a bacterial strain, the bacterial strain selected from the group consisting of an Acinetobacter strain, a Bacillus strain, a Brucella strain, a Burkholderia strain, an Enterococcus strain, an Escherichia strain, a Francisella strain, a Klebsiella strain, a Proteus strain, a Serratia strain, a Streptococcus strain, a Staphylococcus strain, a Yersinia strain, and a combination thereof. In several embodiments, the biological threat is a coronavirus. In several embodiments, the biological threat is SARS-CoV-2. In several embodiments, the sample is selected from the group consisting of a patient sample, an environmental sample, or a personal protection equipment. In several embodiments, the plasmonic particles comprise a metal selected from the group consisting of copper, silver, gold, and a combination thereof. In several embodiments, the biological threat includes a biological weapon of mass destruction. In several embodiments, the biological weapon of mass destruction is an aerosol. In several embodiments, the signature Raman shifts have a plurality of values from 300 cm⁻¹ to 1800 cm⁻¹.

Several embodiments of the present disclosure relate to a method for identifying antibiotic resistance in a bacterial strain sample. In several embodiments, the method includes obtaining a bacterial strain sample comprising one or more plasmonic particles. In several embodiments, the method includes obtaining a Raman spectroscopy spectrum of the bacterial strain sample. In several embodiments, the method includes analyzing the Raman spectrum for one or more signature Raman shifts characteristic of an interaction of the plasmonic particles with proteins conferring resistance to the antibiotic.

Several embodiments of the present disclosure relate to an active personal protection equipment. The active personal protection equipment (active PPE) is capable of interacting with a biological threat. In several embodiments, the active PPE includes a personal protection equipment. In several embodiments, the active PPE includes one or more plasmonic particles. In several embodiments, the plasmonic particles are embedded on the active PPE. In several embodiments, the plasmonic particles are embedded within the active PPE. In several embodiments, the plasmonic particles are present on the surface of the active PPE. The plasmonic particles on the surface of the active PPE are capable of interacting with the biological threat. In several embodiments, the active PPE is used to detect the presence of contamination with the biological threat. In several embodiments, the plasmonic particles of the active PPE comprise a metal selected from the group consisting of copper, silver, gold, and a combination thereof. In several embodiments, an interaction of the plasmonic particles of the active PPE with the biological threat deactivates the biological threat. In several embodiments, the active PPE includes a composition of ionic liquids. In several embodiments, the plasmonic particles and the composition of ionic liquids of the active PPE are electrospun for application onto the active PPE. In several embodiments, the plasmonic particles and the composition of ionic liquids of the active PPE are electrospun for application into the active PPE.

Several embodiments of the present disclosure relate to a device for detecting a biological threat. In several embodiments, the device includes one or more signature Raman shifts characteristic of an interaction of the plasmonic particles with the biological threat. In several embodiments, the device is configured to be used with the diagnostic test as described herein. In several embodiments, the device is configured to be used with the method to detect a biological threat as described herein. In several embodiments, the device is configured to be used with the method for identifying antibiotic resistance as described herein. In several embodiments, the device is configured to be used with the active personal protection equipment. described herein.

### BRIEF DESCRIPTION OF THE DRAWINGS

The drawings described herein constitute part of this specification and includes exemplary embodiments of the present invention which may be embodied in various forms. It is to be understood that in some instances, various aspects of the invention may be shown exaggerated or enlarged to facilitate an understanding of the invention. Therefore, drawings may not be to scale.

FIG. 1 depicts the interaction of HIV-1 with silver nanoparticles.

FIG. 2 depicts the surface enhanced Raman spectroscopy (SERS) spectra for Gp120, calibration, and the silver nanoparticles shown FIG. 1.

FIG. 3 depicts the plasmonic particles in accordance with an embodiment of the present disclosure.

FIG. 4 is an electron micrograph of the plasmonic particles in accordance with an embodiment of the present disclosure.

FIG. 5 depicts a plasmonic particle-based ionic liquid and a plasmonic particle-based deep eutectic solvent, in accordance with an embodiment of the present disclosure.

FIG. 6 depicts a plurality of geranate molecules interacting with a plasmonic particles, in accordance with an embodiment of the present disclosure.

FIG. 7 depicts, a calculated Raman spectrum of 50 atoms of a tryptophan of the nucleotide protein of SARS-CoV-2 (top), a calculated Raman spectrum of 10 atoms of a histidine of the nucleotide protein of SARS-CoV-2 (center), and the Raman spectrum of SARS-CoV-2 (bottom).

FIG. 8A is a SM-SERS spectra of the SARS-CoV-2 virion particle in accordance with an embodiment of the present disclosure.

FIG. 8B is a SM-SERS spectra of the nucleotide protein of SARS-CoV-2 in accordance with an embodiment of the present disclosure.

FIG. 8C is a SM-SERS spectra of the spike protein of SARS-CoV-2 in accordance with an embodiment of the present disclosure.

FIG. 9 is the Raman spectrum of the HCoV-N163 virion particle.

### DETAILED DESCRIPTION

It will be readily understood that the aspects of the present disclosure, as generally described herein, can be arranged, substituted, combined, separated, and designed in a wide variety of different configurations, all of which are explicitly contemplated herein.

Unless defined otherwise, technical and scientific terms used herein have the same meaning as commonly understood by one of ordinary skill in the art to which the present disclosure belongs. All patents, applications, published applications and other publications referenced herein are expressly incorporated by reference in their entireties unless stated otherwise. For purposes of the present disclosure, the following terms are defined below.

The present disclosure overcomes the existing hinderances of accurate detection by creating Raman signatures for biological threats that are enhanced using single molecule surface enhanced Raman spectroscopy (SM-SERS). The enhancements are produced via two effects of specially manufactured substrates containing plasmonic particles: 1) an electromagnetic effect that allows plasmonic enhancement of the plasmonic particles, and 2) a chemical effect that results from charge transfer between the analyte molecule and the SERS substrate.

This technology includes advanced substrates based on engineered bimetallic plasmonic particles that have been proven to result in a giant enhancement factor of the Raman signal of up to 1013 times, therefore allowing single molecule detection of biothreat agents for higher sensitivity and reliability.

Described herein are diagnostic tests and methods are based on the use of Raman spectroscopy for the detection of biological threats. Raman spectroscopy reveals the vibrational and rotational modes of a molecule and therefore, provides a unique fingerprint (i.e., signature Raman shifts), of the molecule. The signal is produced by inelastic scattering of light, and it is therefore very weak. Surface-enhanced Raman spectroscopy (SERS) provides an enhancement of the signal by a factor of 10⁵-10¹¹ which makes single molecule detection possible. When employing SERS, the molecule must be in contact with a metal nanoparticle with strong plasmonic effects.

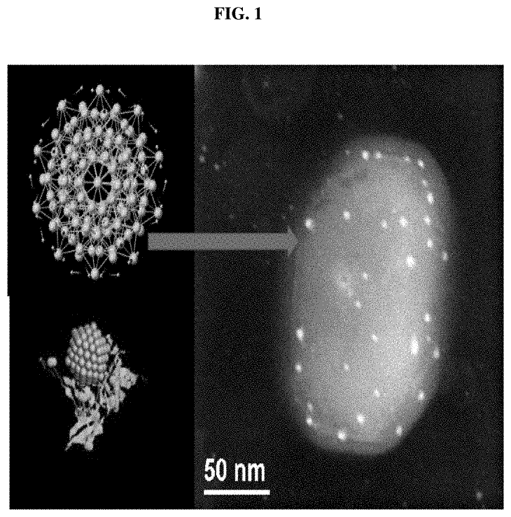

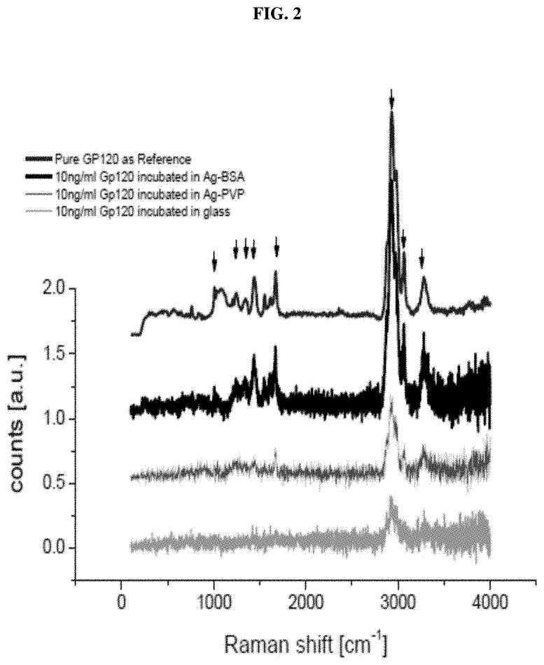

It is known that metallic nanoparticles are capable of interacting with the HIV-1 virus. Specifically, silver nanoparticles tend to bind on the virus spike glycoproteins as shown in FIG. 1. Based on this principle, a spike protein can also interact with metallic nanoparticles. As shown in FIG. 2, the Gp-120 glycoprotein of HIV-1 can be detected by SERS. Interestingly, there is evidence that silver nanoparticles can deactivate many viruses including HIV-1, H3N2, HSV-1, and HAV-10 that also have glycoproteins on their exterior layer. As the morphology of coronaviruses (e.g., COVID-19, SARS, MERS) comprises viral spike peplomers on the surface, coronaviruses may also detected by SERS.

### Diagnostic Test

Several embodiments of the present disclosure relate to a diagnostic test to determine the presence of a biological threat. The diagnostic test includes a surface-enhanced Raman spectrometer. The diagnostic test of a sample suspected to be contaminated with a biological threat is performed on the surface-enhanced Raman spectrometer to produce a Raman spectrum. The diagnostic test requires less than 5 minutes to perform, is inexpensive and reliable and has high sensitivity. The SERS spectrum can be obtained in few minutes with initial calibrations performed daily in 20 minutes. In several embodiments, the diagnostic test includes a substrate that includes one or more plasmonic particles. Plasmonic particles can be synthesized very easily in large quantities and used for detecting multiple pathogens and provide an advantage over RT-PCR methods that requires expensive pathogen specific fluorescent DNA probes. In several embodiments, the plasmonic particles of the diagnostic test include a metal selected from the group consisting of copper, silver, gold, and a combination thereof. In several embodiments, the substrate comprises molybdenum disulfide. In several embodiments, the biological threat is a virus or a bacterial strain. In several embodiments, the biological threat is a coronavirus. In several embodiments, the biological threat is SARS-CoV-2. In several embodiments, the biological threat includes a biological weapon of mass destruction. In some embodiments, the biological weapon of mass destruction may include a bacterial or viral source. In some embodiments, a biological weapon of mass destruction may include a plague virus, anthrax, small pox, hepatitis, avian influenza, and Q fever. In some embodiments, a biological weapon of mass destruction may include a toxin. In some embodiments, a biological weapon of mass destruction may include botulism, ricin, and Staphylococcus. In several embodiments, the biological weapon of mass destruction is an aerosol.

Specifically, a sample suspected of biological threat contamination is collected; this sample may be a laboratory sample acquired by a patient presumed to be infected, an aerosol sample, an environmental sample, or it may be a piece of personal protection equipment as described in more detail below. In the case of the laboratory sample, a patient sample is applied to a substrate comprising one or more plasmonic particles. The sample is then run through a process employing SERS, and a SERS spectrum is produced. The spectrum is then analyzed for Raman shifts that are characteristic of an interaction between a plasmonic particle and the virus or bacterial pathogen; if these known shifts are present, the sample is determined to be positive for biothreat contamination.

As discussed previously, the two most significant problems associated with the current Raman spectroscopy approach used for detection of a biological threat include: 1) a weak, low-intensity signal that requires a significant number of target molecules to be present to facilitate detection, and 2) the fluorescence effect in biomolecules that introduces noise on the Raman spectra. The intensity of the Raman signal is very low; for example, if the laser has 1 watt of power, the light coming out with the Raman signal will be near 1/1,000,000 of a watt. Although the use of SERS helps increase the signal, plasmonic amplification increases the signal further on the order of 10⁷. Nonetheless, this signal increase does not address the additional issues with signal noise.

To overcome these problems, the present disclosure describes alternative Raman signatures that are enhanced using Single Molecule Surface Enhanced Raman spectroscopy (SM-SERS). The present method adds a second amplification factor using a 2-D material substrate wherein excitonic transitions transfer charge between the substrate and the analyte, adding an additional amplification of 10⁵.

Specifically, the enhancements will be produced via two effects of specially manufactured substrates containing plasmonic particles: 1) an electromagnetic effect that allows plasmonic enhancement of the plasmonic particles, and 2) a chemical effect that results from charge transfer between the analyte molecule and the SERS substrate. These substrates are based on engineered plasmonic particles supported on a monolayer of molybdenum disulfide (MoS₂) material. This combines the SERS hot spots on the plasmonic particles with the 2-D properties of the MoS₂ which induces charge transfer. The result is a giant enhancement factor of the signal of up to 10¹³ times.

The second problem of employing Raman spectroscopy on organic material is fluorescence. Machine learning is utilized to eliminate fluorescence by removing the fluorescent peaks in signal. The SERS substrate is optimized to obtain single molecule detection and reduces the fluorescence problem by using a desktop Raman Horiba Xplora with a near infrared 785 nm laser wavelength and applying machine learning protocols to analyze spectra to identify the peaks corresponding to the analyte. This will be complemented with theoretical calculations of the spectra that will be useful in signal filtering.

### Detection Method

Several embodiments of the present disclosure relate to a method to detect a biological threat. In several embodiments, the method includes obtaining a sample suspected of comprising the biological threat. In several embodiments, the sample includes one or more plasmonic particles. In several embodiments, the method includes applying Raman spectroscopy on the sample to produce a Raman spectrum. In several embodiments, the method includes analyzing the Raman spectrum for one or more signature Raman shifts characteristic of an interaction of the plasmonic particles with the biological threat.

In several embodiments, the signature Raman shifts include Raman shift peaks from SARS-CoV-2. In several embodiments, the Raman shift peaks are associated with a SARS-CoV-2 virion particle, nucleotide proteins of SARS-CoV-2, spike proteins SARS-CoV-2, or any combination of the foregoing. In several embodiments, the signature Raman shifts have a plurality of values from 300 cm⁻¹ to 3000 cm⁻¹, or from 300 to 1800 cm⁻¹, or from 500 to 1700 cm⁻¹. In several embodiments, the signature Raman shifts have values of 501.5 cm⁻¹, 531.7 cm⁻¹, 577.0 cm⁻¹, 656.2 cm⁻¹, 716.7 cm⁻¹, 782.5 cm⁻¹, 846.5 cm⁻¹, 902.3 cm⁻¹, 951.5 cm⁻¹, 983.7 cm⁻¹, 1060.3 cm⁻¹, 1121 cm⁻¹, 1150 cm⁻¹, 1207 cm⁻¹, 1263 cm⁻¹, 1297.4 cm⁻¹, 1340.4 cm⁻¹, 1378 cm⁻¹, 1445.1 cm⁻¹, 1492.1 cm⁻¹, 1554.0 cm⁻¹, 1626.7 cm⁻¹, and any combination of the foregoing. In several embodiments, the signature Raman shifts have values of 410.5 cm⁻¹, 432 cm⁻¹, 442.6 cm⁻¹, 478.0 cm⁻¹, 498.9 cm⁻¹, 511.0 cm⁻¹, 528.7 cm⁻¹, 545.5 cm⁻¹, 601.0 cm⁻¹, 633.8 cm⁻¹, 651.7 cm⁻¹, 678.4 cm⁻¹, 716.5 cm⁻¹, 786.0 cm⁻¹, 801.1 cm⁻¹, 849.0 cm⁻¹, 875.8 cm⁻¹, 891.9 cm⁻¹, 920.3 cm⁻¹, 1033.1 cm⁻¹, 1050.2 cm⁻¹, 1081.0 cm⁻¹, 1100.2 cm⁻¹, 1115.6 cm⁻¹, 1128.0 cm⁻¹, 1150.2 cm⁻¹, 1220.1 cm⁻¹, 1250.7 cm⁻¹, 1270.7 cm⁻¹, 1305.9 cm⁻¹, 1320.0 cm⁻¹, 1356.7 cm⁻¹, 1383.9 cm⁻¹, 1449.8 cm⁻¹, 1463.7 cm⁻¹, and any combination of the foregoing. In several embodiments, the signature Raman shifts have values of 373.8 cm⁻¹, 419.6 cm⁻¹, 495.2 cm⁻¹, 602.1 cm⁻¹, cm⁻¹, 654.5 cm⁻¹, cm⁻¹, 678.4 cm⁻¹, 729.8 cm⁻¹, cm⁻¹, 783.46 cm⁻¹, cm⁻¹, 823.8 cm⁻¹, cm⁻¹, 852.4 cm⁻¹, cm⁻¹, 862 cm⁻¹, 922.3 cm⁻¹, 975.8 cm⁻¹, 1050.0 cm⁻¹, 1076.7 cm⁻¹, 1107.8 cm⁻¹, cm⁻¹, 1219.3 cm⁻¹, cm⁻¹, 1248.6 cm⁻¹, 1266.9 cm⁻¹, 1320.7 cm⁻¹, 1390.0 cm⁻¹, 1458.1 cm⁻¹, 1517.4 cm⁻¹, 1554.9 cm⁻¹, 1608.0 cm⁻¹, 1671.7 cm⁻¹, and any combination of the foregoing.

In several embodiments, the biological threat is a virus or a bacterial strain. In several embodiments, the biological threat is a bacterial strain, the bacterial strain selected from the group consisting of an Acinetobacter strain, a Bacillus strain, a Brucella strain, a Burkholderia strain, an Enterococcus strain, an Escherichia strain, a Francisella strain, a Klebsiella strain, a Proteus strain, a Serratia strain, a Streptococcus strain, a Staphylococcus strain, a Yersinia strain, and a combination thereof. In several embodiments, the biological threat is a coronavirus. In several embodiments, the biological threat is SARS-CoV-2. In several embodiments, the sample is selected from the group consisting of a patient sample, an environmental sample, or a personal protection equipment. In several embodiments, the plasmonic particles comprise a metal selected from the group consisting of copper, silver, gold, and a combination thereof. In several embodiments, the biological threat includes a biological weapon of mass destruction. In some embodiments, the biological weapon of mass destruction may include a bacterial or viral source. In some embodiments, a biological weapon of mass destruction may include a plague virus, anthrax, small pox, hepatitis, avian influenza, and Q fever. In some embodiments, a biological weapon of mass destruction may include a toxin. In some embodiments, a biological weapon of mass destruction may include botulism, ricin, and staff. In several embodiments, the biological weapon of mass destruction is an aerosol.

### Plasmonic Particles

The plasmonic particles of the present disclosure include metallic plasmonic particles and any other type of plasmonic particle capable of producing a signal via Raman spectroscopy (e.g., SERS) and/or interacting with the surface of a virus.

In one embodiment, the plasmonic particles include one or more metals. In one embodiment, the plasmonic particles include one or more metals selected from copper, silver, gold, and a combination thereof. In one embodiment, the plasmonic particles include copper, silver, and gold. In one embodiment, the plasmonic particles include copper and silver. In one embodiment, the plasmonic particles include copper and gold. In one embodiment, the plasmonic particles include silver and gold. The plasmonic particles may have a geometric shape nonlimiting examples of which include a pentagon and a star shape. In one embodiment, the plasmonic particles have a star shape. In one embodiment, the plasmonic particles have a star shape that includes from four to twelve arms. In one embodiment, each arm has a length from 50 nm to 500 nm. In one embodiment, each arm has a width from 2 nm to 50 nm. In one embodiment, the arms are arranged symmetrically or a symmetrically. In one embodiment an angle between any two arms is from 20 degrees to 90 degrees.

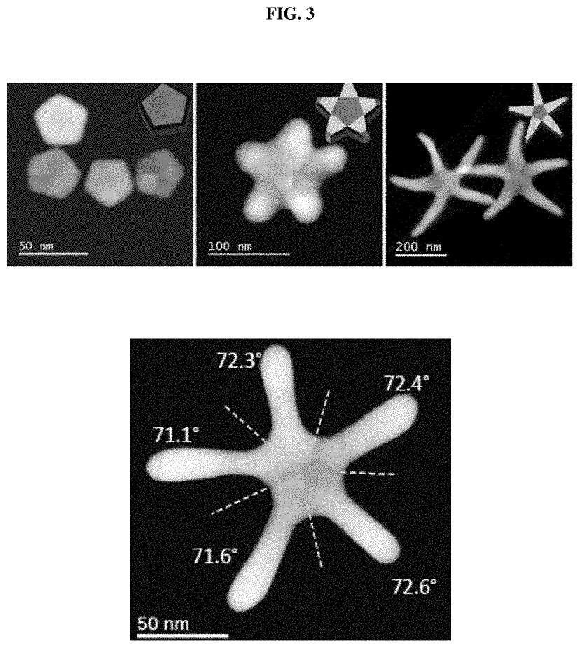

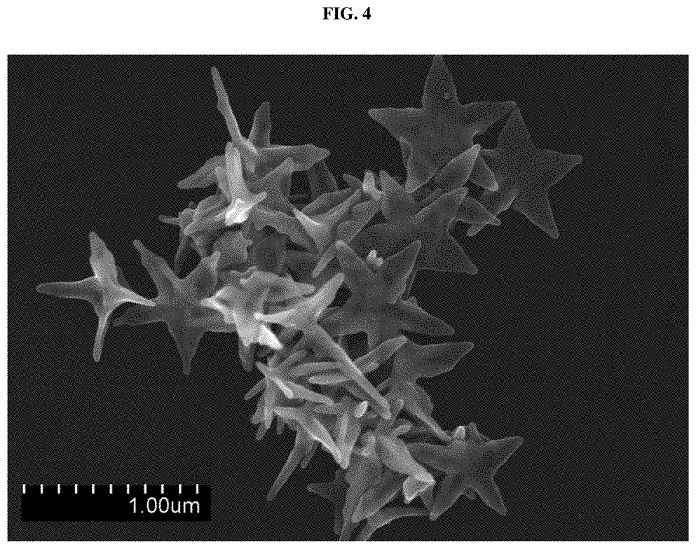

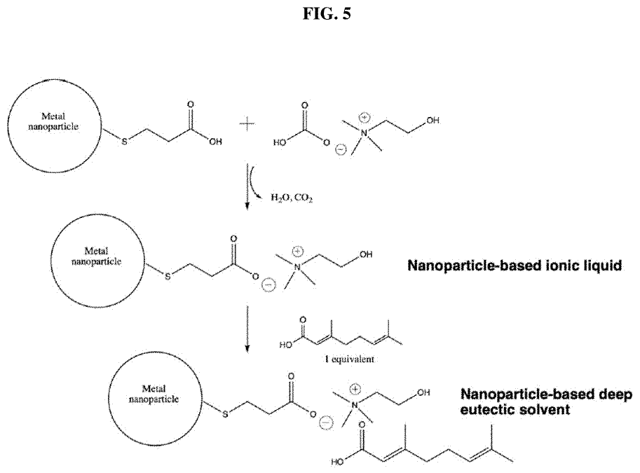

In one embodiment, the plasmonic particles have a star shape that includes five arms, each arm having a length of 75-90 nm and a width of 10-20 nm. The five arms are arranged symmetrically with an angle between any two arms of 70-75 degrees. Some embodiments of the plasmonic particles are shown in FIGS. 3-4. The star-shaped plasmonic particles absorb light at two optimum wavelengths: one in the green region and one in the near infrared region of the spectrum. This increases the efficiency of the entire Raman process as the absorbed light is remitted and heat these molecules, further reducing the fluorescent noise.

In one embodiment, the plasmonic particles are included into solutions of ionic liquids to improve dispersal and limit aggregation. In these formulations, the ionic liquids exist in a relatively high concentration relative to the plasmonic particles. The improved dispersion serves to increase the probability that individual plasmonic particles will be accessible to reach the target pathogen. In one embodiment, the ionic liquid comprises choline and carboxylic acid anions. In one embodiment, the ionic liquid comprises choline and geranate (CAGE). In order to realize an optimal effect, dispersed plasmonic particles are desired to interact with the target molecules. The SERS signal arises from a single plasmonic particle interacting with a single target compound. Aggregation of plasmonic particles in solution causes the particles to clump together and not interact with the target and reduces the efficiency of the spectroscopic process. Metallic plasmonic particles that are covalently bound to ligands containing distal carboxylic acid groups (such as gold nanoparticles bound to lipoic acid or cysteine) may themselves serve as substrates for formation of ionic liquids (via a salt metathesis reaction of the carboxylic acid group with choline or other cations) or for deep eutectic solvents/eutectic mixtures (via including the plasmonic particles-acid as a neutral species in an equimolar cation:anion ionic liquid). Ionic liquids may be chosen to impart favorable properties (such as dispensability or affinity for membranes) to this new material.

Metallic plasmonic particles that are covalently bound to small molecule organic acids are also known. In these cases, a thiol functionality on an organic acid (such as lipoic acid or cysteine) physically makes a covalent bond with the metal center (typically gold atoms). These metallic plasmonic particles are thus physically bound to the organic acid molecule, but the thiol is participating in the linkage and the organic acid remains free to participate in other reactions. The presence of the acidic protonated carboxylate may be utilized in a salt metathesis reaction with a cationic substrate (such as choline bicarbonate) to form a new ionic bond between the cation and the plasmonic particle attached-anion. In essence, this is a means to make a new ionic liquid (with one component of the liquid being a metallic plasmonic particle). Further, one could envision mixing an already formed ionic liquid (an equimolar mixture of a cation and an anion) with the plasmonic particle/acid conjugate and forming a new deep eutectic solvent/eutectic mixture (in this case the plasmonic particle/acid conjugate serves as a neutral species to interact with the equimolar ionic liquid.

The benefit to this approach is that it provides a new route to novel, plasmonic particle containing ionic liquids or deep eutectic solvents that may be deployed for pathogen inactivation or detection. Further, formulation of this new material may enable inclusion of plasmonic particles (as ionic liquids) into solid materials via electrospinning or rotational spinning using previously patented technology.

Dispersal enables smaller working concentrations of plasmonic particles to be used to realize the desired effect, whether it is a SERS signal from a target molecule or plasmonic particle-based inactivation of a target pathogen. Formulation of the plasmonic particles in an ionic liquid matrix (which are well known to be disruptive to common intermolecular forces at the root of the aggregation) may serve to limit their aggregation in aqueous solution and thus lower the reagent requirement for the functionality of these materials in a given assay. This is positioned both to lessen any deleterious effects associated with the high concentrations, as well as to reduce the cost associated with the nanoparticle reagents as well.

In one embodiment, the plasmonic particles are “capped” with isoprenoid acid ligands to increase the affinity of the plasmonic particles to membrane bilayers. In an aqueous system, the relatively hydrophobic plasmonic particles will be thermodynamically driven to associate with non-polar environments (specifically, the outer membrane of cells that are present) rather than persist in water. Association of the plasmonic particles with membranes is expected to greatly enhance the likelihood of plasmonic particles interaction with proteins in these membranes that may provide diagnostic signatures through SM-SERS. These new formulations may also facilitate inactivation of viruses or other pathogens. It is known that the properties of plasmonic particles can be modified by surface modification. In the context of this invention, the surfaces may either be modified by covalent bonds of an organic compound to the metal atoms in the plasmonic particles, or by non-covalent, ionic interactions of various organic anions with the cationic metal atoms in the plasmonic particle. Regarding the latter, addition of organic anions to plasmonic particles syntheses has been shown to be a convenient strategy to limit size/shape of plasmonic particles and/or introduce favorable properties. This strategy of surface modification is known as “capping” of the plasmonic particles with various organic groups (https://doi.org/10.1016/j.matchemphys.2016.02.024). Specifically, geranic acid was one of a number of compounds used to make modified plasmonic particles for use as novel electrically conductive inks. See U.S. Pat. No. 8,362,350B2 and (https://pubs.rsc.org/en/content/articlelanding/2013/tc/c2tc00336h#!divAbstract). The modification to these plasmonic particles served to aid their fluidity in bulk and ultimately their dispersal and deposition onto other surfaces.

This work is poised to use similar methods to develop metal plasmonic particles that are capped with short, hydrophobic alkyl acids such as geranic, citronellic, and oleic acid (among others). Unlike previous reports, we will then use these capped (and hydrophobic) plasmonic particles formulations in an aqueous assay for pathogen detection. The capping step will aid dispersal/minimize plasmonic particle aggregation in solution but will also decrease the solubility of the formulations in water. More specifically, the organic acid group on the surface of the plasmonic particle will be driven via thermodynamics to associate with other hydrophobic environments that may be present in the mixture—namely, the outer membranes of the target cells. Our work has already demonstrated two important things relevant to this goal. First, computational studies of the ionic liquid choline geranate in water show that the hydrophobic moieties of the material (such as geranic acid or geranate anion) readily partition into model membranes from aqueous environments. While this is not unexpected, these same models show that the choline cation present in choline geranate (while largely still solvated in the aqueous phase) retains a tendency to closely interact with the negative charges on the surface of these model membranes. Stated another way, in this model, when CAGE is dispersed into water in the presence of a model bacterial membrane, the hydrophobic groups associate into the bacterial membrane but also wind up delivering the choline to the membrane's surface.

This simple step of capping the plasmonic particles with an alkyl acid may itself provide valuable materials for the SERS assay. In principle, positively charged atoms within a plasmonic particle capped with an equimolar (or less than equimolar) amount of alkyl anion are not unlike conventional ionic liquids (themselves composed of equimolar concentrations of cations and anionic components). However, unlike previously described methods, we are also positioned to then use the capped plasmonic particles (ionic liquids) themselves as a reagent for the formation of plasmonic particles containing deep eutectic solvents via the addition of further equivalents of a neutral species. These formulations can add even further functionality to the bulk materials, including more complete solvation into water. Further, the formulations may themselves have antibacterial/antiviral effects, and may aid deactivation of the virus and detection in a single step.

### Personal Protection Equipment

Several embodiments of the present disclosure relate to personal protection equipment that includes the plasmonic particles as described herein. The incorporation of plasmonic particles has two potential benefits: 1) it allows the equipment to be used as a sample in the diagnostic test described above to determine if the equipment is contaminated with the virus, and 2) the plasmonic particles may interact with and deactivate the virus to prevent or at least decrease the chance of viral infection to the individual wearing the equipment.

Personal protection equipment (PPE) may comprise a wide range of products including, but not limited to, facemasks, eye spectacles/lenses, goggles, face shields, gloves, ear protectors, among others as described by the Occupational Safety and Health Administration (OSHA®). In practice, this equipment may include any materials designed to protect against human health hazards such as airborne biological particles, infected surfaces, and other sources of contamination.

In certain embodiments, ionic liquids are incorporated into the diagnostic test and/or the personal protection equipment. As described in more detail in U.S. patent application Ser. No. 16/307,347 entitled “Novel Antibiofilm Deep Eutectic Solvent Formulations”, certain formulations of ionic liquids (sometimes referred to as deep eutectic solvents, eutectic mixtures, or binary mixtures) have antimicrobial activity and may be useful in surface decontamination.

In some embodiments, ionic liquids are incorporated into materials or textiles of personal protection equipment. In specific embodiments, ionic liquid formulations are used for suspending the plasmonic particles for application into materials for personal protection equipment. In one application, electrospinning a composition comprising ionic liquid formulations and plasmonic particles into a scaffold provides a means to incorporate the composition in materials.

In one embodiment, the method of detection is performed on a sample selected from a patient sample, an environmental sample, or personal protection equipment. Patient samples include samples containing or derived from the nasal cavity, pharyngeal regions, blood, bone marrow, placental or umbilical cords, urine, feces, cerebrospinal fluid, pleural fluid, amniotic fluid, peritoneal fluid, lymphatic system, saliva, mouth, breath, skin, tissue, among others as performed in the clinical field.

Environmental samples include aerosol samples, water samples, soil samples, air samples, particle samples, waste samples, or other sample collected to test for a biological threat in the environment.

Other suitable examples include personal protective equipment as described elsewhere herein.

### Biological Threats

Specific biological threats that may be suited for the present method include, but are not limited to viruses and bacterial strains.

Specific viral threats applicable herein include but are not limited to: Coronaviridae strains including SARS-CoV-1 (SARS), SARS-CoV-2 (COVID-19), MERS-CoV (MERS). Other viruses include hemorrhagic fever viruses, Variola viruses (e.g., smallpox, alastrim), Ebola virus, Foot-and-mouth disease virus, and Marburg virus. Other examples of biological threats that may be applicable to the present disclosure include those found in the Federal Select Agent Program included herein by reference (https://www.selectagents.gov/SelectAgentsandToxinsList.html).

Specific biological threats comprising bacterial strains applicable herein include but are not limited to Acinetobacter strains (A. baumannii), Bacillus strains (B. anthracis, B. cereus, B. subtilis), Brucella strains (B. abortus, B. melitensis, B. suis), Burkholderia strains (B. cepacia, B. cenocepacia, B. mallei, B. multivorans, B. pseudomallei), Enterococcus strains (E. faecalis), Escherichia strains (E. coli), Francisella strains (F. novicida, F. philomiragia, F. tularensis), Klebsiella strains (K. oxytoca, K. pneumoniae, K. variicola), Proteus strains (P. mirabilis, P. penneri, P. vulgaris), Serratia strains (S. fonticola, S. liquefaciens, S. marcescens, S. odorifera, S. plymuthica, S. quinivoran, S. rubidae), Streptococcus strains (S. agalactiae, S. anginosus, S. bovis, S. dysgalactiae, S. mitis, S. mutans, S. pneumoniae, S. pyogenes, S. sanguinis, S. suis), Staphylococcus strains (S. aureus, S. epidermidis, S. saprophyticus), Yersinia strains (Y enterocolitica, Y. pestis).

Antibiotic resistance in pathogenic bacteria is a serious threat to our ability to threat infections. The drug-resistant phenotypes are frequently mediated by proteins expressed by the bacteria and offer the potential to rapidly guide therapeutic strategies. For example, the pathogen bacterium Staphylococcus aureus becomes methicillin resistant through the production of the mecA protein. SERS spectral signature from the mecA protein would allow the differentiation of methicillin-resistant S. aureus (MRSA) from methicillin-sensitive S. aureus (MSSA). There are many other examples where different proteins could be used to identify drug-resistant pathogens.

It is important to note that the SERS method is not appropriate for all viruses and bacteria. In each case, the size and shape of the plasmonic particles, the laser light, and the peak analysis needs to be optimized to produce the spectra. Thus, existing methods employing Raman spectroscopy or SERS in particular may not be at all suitable for the detection of biological threats are described herein.

### Signature Raman Shift Sets

Several embodiments of the present disclosure relate to one or more signature Raman shift sets. The term “signature Raman shift,” as used herein, is a Raman shift value reported in units of wavenumbers (cm⁻¹). The term “signature Raman shift set,” as used herein, is one or more Raman shift values of the sample. In several embodiments, the sample is a biological threat as defined elsewhere herein. In several embodiments, the sample is a biological weapon of mass destruction. In several embodiments, the signature Raman shift set is associated with a biological sample and the signature Raman shift set differentiates the biological sample from a related species. In several embodiments, the signature Raman shift set is associated with a related species of a biological sample.

In several embodiments, the signature Raman shift set is a signature of a virus or a bacterial strain. In several embodiments, the signature Raman shift set is a signature of one or more Bacillus strains. In several embodiments, signature Raman shift set is a signature of Bacillus anthracis, Bacillus pseudomallei, Bacillus cereus, Bacillus thailandensis, Bacillus humptydooensis, and combinations of any of the foregoing. In several embodiments, the signature Raman shift set is a signature of Yersinia pestis, Francisella tularensis, Burkholderia pseudomallei. and combinations of any of the foregoing. In several embodiments, the signature Raman shift set is a signature of a whole microbe cell or a whole microbe spore. In several embodiments, the signature Raman shift set is a signature of an individual spore. In several embodiments, the signature Raman shift set is a signature of spore cluster, where the spore cluster include several related species of a biological sample. In several embodiments, the signature Raman shift set is a signature of an individual cell. In several embodiments, the signature Raman shift set is a signature of cell cluster, where the cell cluster include several related species of a biological sample.

In several embodiments, the signature Raman shift set is a signature of one or more proteins. In several embodiments, the protein is associated with a biological threat a biological weapon of mass destruction. In several embodiments, the signature Raman shift set includes protein secondary structure information. The protein secondary structure information includes information for Amide I stretching, Amide III position, and bonds including S—S, C—OH, CH₂, CH₃, N—CH₃, aromatic CH, and C—CH₂ bonds in aromatic and aliphatic compounds.

In several embodiments, the signature Raman shift set includes Raman shift peaks from SARS-CoV-2. In several embodiments, the Raman shift peaks are associated with a SARS-CoV-2 virion particle, nucleotide proteins of SARS-CoV-2, spike proteins SARS-CoV-2, or any combination of the foregoing. In several embodiments, the signature Raman shift set has a plurality of values from 300 cm⁻¹ to 3000 cm⁻¹, or from 300 to 1800 cm⁻¹, or from 500 to 1700 cm⁻¹. In several embodiments, the signature Raman shift set has values of 501.5 cm⁻¹, 531.7 cm⁻¹, 577.0 cm⁻¹, 656.2 cm⁻¹, 716.7 cm⁻¹, 782.5 cm⁻¹, 846.5 cm⁻¹, 902.3 cm⁻¹, 951.5 cm⁻¹, 983.7 cm⁻¹, 1060.3 cm⁻¹, 1121 cm⁻¹, 1150 cm⁻¹, 1207 cm⁻¹, 1263 cm⁻¹, 1297.4 cm⁻¹, 1340.4 cm⁻¹, 1378 cm⁻¹, 1445.1 cm⁻¹, 1492.1 cm⁻¹, 1554.0 cm⁻¹, 1626.7 cm⁻¹, and any combination of the foregoing. In several embodiments, the signature Raman shift set has values of 410.5 cm⁻¹, 432 cm⁻¹, 442.6 cm⁻¹, 478.0 cm⁻¹, 498.9 cm⁻¹, 511.0 cm⁻¹, 528.7 cm⁻¹, 545.5 cm⁻¹, 601.0 cm⁻¹, 633.8 cm⁻¹, 651.7 cm⁻¹, 678.4 cm⁻¹, 716.5 cm⁻¹, 786.0 cm⁻¹, 801.1 cm⁻¹, 849.0 cm⁻¹, 875.8 cm⁻¹, 891.9 cm⁻¹, 920.3 cm⁻¹, 1033.1 cm⁻¹, 1050.2 cm⁻¹, 1081.0 cm⁻¹, 1100.2 cm⁻¹, 1115.6 cm⁻¹, 1128.0 cm⁻¹, 1150.2 cm⁻¹, 1220.1 cm⁻¹, 1250.7 cm⁻¹, 1270.7 cm⁻¹, 1305.9 cm⁻¹, 1320.0 cm⁻¹, 1356.7 cm⁻¹, 1383.9 cm⁻¹, 1449.8 cm⁻¹, 1463.7 cm⁻¹, and any combination of the foregoing. In several embodiments, the signature Raman shift set has values of 373.8 cm⁻¹, 419.6 cm⁻¹, 495.2 cm⁻¹, 602.1 cm⁻¹, cm⁻¹, 654.5 cm⁻¹, cm⁻¹, 678.4 cm⁻¹, 729.8 cm⁻¹, cm⁻¹, 783.46 cm⁻¹, cm⁻¹, 823.8 cm⁻¹, cm⁻¹, 852.4 cm⁻¹, cm⁻¹, 862 cm⁻¹, 922.3 cm⁻¹, 975.8 cm⁻¹, 1050.0 cm⁻¹, 1076.7 cm⁻¹, 1107.8 cm⁻¹, cm⁻¹, 1219.3 cm⁻¹, cm⁻¹, 1248.6 cm⁻¹, 1266.9 cm⁻¹, 1320.7 cm⁻¹, 1390.0 cm⁻¹, 1458.1 cm⁻¹, 1517.4 cm⁻¹, 1554.9 cm⁻¹, 1608.0 cm⁻¹, 1671.7 cm⁻¹, and any combination of the foregoing.

In several embodiments, the signature Raman shift set is a signature of an aerosol. In several embodiments, the signature Raman shift set includes information of compounds and particles commonly found in aerosol samples such as pollen, silicates, iron oxides, and the like.

In several embodiments, the signature Raman shift set is complemented with theoretical calculations of the spectra that enhance signal filtering.

Several embodiments of the present disclosure are related to biological weapon aerosol signatures. As used herein, the term “biological weapon aerosol signature” is a signature Raman shift set of a biological weapon of mass destruction in an aerosol. In several embodiments, the biological weapon aerosol signature is used in a network of sensors to detect the presence of a biological weapon of mass destruction in an aerosol. In several embodiments, the network of sensors includes near real time portable sensors. In several embodiments, the biological weapon aerosol signatures have a lower limit of detection and a lower false positive rate compared to the Battelle Rapid Enumerated Bioidentification System (REBS). In several embodiments, the biological weapon aerosol signatures include an estimated time to results of just two minutes and is faster than REBS.

### Device for Detecting a Biological Threat

Several embodiments of the present disclosure relate to a device for detecting a biological threat. In several embodiments, the device is includes one or more signature Raman shifts characteristic of an interaction of the plasmonic particles with the biological threat. In several embodiments, the signature Raman shifts include Raman shift peaks from SARS-CoV-2. In several embodiments, the Raman shift peaks are associated with a SARS-CoV-2 virion particle, nucleotide proteins of SARS-CoV-2, spike proteins SARS-CoV-2, or any combination of the foregoing. In several embodiments, the signature Raman shifts have a plurality of values from 300 cm⁻¹ to 3000 cm⁻¹, or from 300 to 1800 cm⁻¹, or from 500 to 1700 cm⁻¹. In several embodiments, the signature Raman shifts have values of 501.5 cm⁻¹, 531.7 cm⁻¹, 577.0 cm⁻¹, 656.2 cm⁻¹, 716.7 cm⁻¹, 782.5 cm⁻¹, 846.5 cm⁻¹, 902.3 cm⁻¹, 951.5 cm⁻¹, 983.7 cm⁻¹, 1060.3 cm⁻¹, 1121 cm⁻¹, 1150 cm⁻¹, 1207 cm⁻¹, 1263 cm⁻¹, 1297.4 cm⁻¹, 1340.4 cm⁻¹, 1378 cm⁻¹, 1445.1 cm⁻¹, 1492.1 cm⁻¹, 1554.0 cm⁻¹, 1626.7 cm⁻¹, and any combination of the foregoing. In several embodiments, the signature Raman shifts have values of 410.5 cm⁻¹, 432 cm⁻¹, 442.6 cm⁻¹, 478.0 cm⁻¹, 498.9 cm⁻¹, 511.0 cm⁻¹, 528.7 cm⁻¹, 545.5 cm⁻¹, 601.0 cm⁻¹, 633.8 cm⁻¹, 651.7 cm⁻¹, 678.4 cm⁻¹, 716.5 cm⁻¹, 786.0 cm⁻¹, 801.1 cm⁻¹, 849.0 cm⁻¹, 875.8 cm⁻¹, 891.9 cm⁻¹, 920.3 cm⁻¹, 1033.1 cm⁻¹, 1050.2 cm⁻¹, 1081.0 cm⁻¹, 1100.2 cm⁻¹, 1115.6 cm⁻¹, 1128.0 cm⁻¹, 1150.2 cm⁻¹, 1220.1 cm⁻¹, 1250.7 cm⁻¹, 1270.7 cm⁻¹, 1305.9 cm⁻¹, 1320.0 cm⁻¹, 1356.7 cm⁻¹, 1383.9 cm⁻¹, 1449.8 cm⁻¹, 1463.7 cm⁻¹, and any combination of the foregoing. In several embodiments, the signature Raman shifts have values of 373.8 cm⁻¹, 419.6 cm⁻¹, 495.2 cm⁻¹, 602.1 cm⁻¹, cm⁻¹, 654.5 cm⁻¹, cm⁻¹, 678.4 cm⁻¹, 729.8 cm⁻¹, cm⁻¹, 783.46 cm⁻¹, cm⁻¹, 823.8 cm⁻¹, cm⁻¹, 852.4 cm⁻¹, cm⁻¹, 862 cm⁻¹, 922.3 cm⁻¹, 975.8 cm⁻¹, 1050.0 cm⁻¹, 1076.7 cm⁻¹, 1107.8 cm⁻¹, cm⁻¹, 1219.3 cm⁻¹, cm⁻¹, 1248.6 cm⁻¹, 1266.9 cm⁻¹, 1320.7 cm⁻¹, 1390.0 cm⁻¹, 1458.1 cm⁻¹, 1517.4 cm⁻¹, 1554.9 cm⁻¹, 1608.0 cm⁻¹, 1671.7 cm⁻¹, and any combination of the foregoing.

The device is configured to be used with the diagnostic tests, methods of detecting, methods of identifying, and active personal protection equipment described elsewhere herein. The device includes at least one of the signature Raman shift sets described elsewhere herein. In several embodiments, new signature Raman shift sets can be installed onto the device.

In several embodiments, the device performs the diagnostic tests, methods of detecting, methods of identifying, as described herein. In several embodiments, the device requires less than five minutes to perform a diagnostic test, method of detecting, and/or method of identifying. In several embodiments, the device identifies and/or detects one or more biological threats in a single measurement.

In several embodiments, the device includes a 785 nm Laser and a 1064 nm Infrared laser. In several embodiments, the device includes data analysis capabilities. In several embodiments, the device includes machine learning processes. In several embodiments, the device is a portable, handheld, battery powered device with a cost of $5,000 to $10,000.

The described features, advantages, and characteristics may be combined in any suitable manner in one or more embodiments. One skilled in the relevant art will recognize that the circuit may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrase “in one embodiment,” “in an embodiment,” and similar language throughout this specification may, but do not necessarily, all refer to the same embodiment.

### EXAMPLES

### Example 1

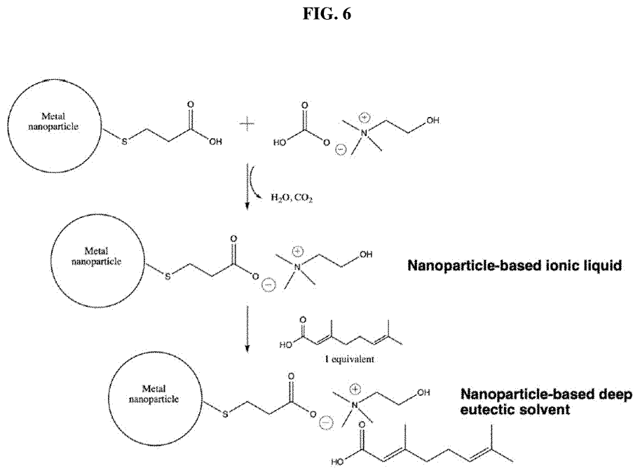

Performing Raman spectroscopy on virion particles is complicated by the numerous molecular vibrations of the multiple macromolecules that result in many closely spaced Raman signals and broad peaks of overlapping signals. To obtain an accurate analysis of SARS-CoV-2 and associated proteins the individual components of the spectra must be deconvoluted with computational methods. For example, the results of Gaussian calculations of Hartree-Fock approximations for 50 atoms of a tryptophan and 10 atoms of a histidine of the Raman spectra of the nucleotide protein of SARS-CoV-2 are shown at the top and center of FIG. 6, respectively. Numerous peaks overlap and coincide with observed positions of the SARS-CoV-2 spectra around 1000 cm⁻¹ to produce broadening of the peaks, as shown at the bottom of FIG. 6.

### Example 2

Hydrogen tetrachloroaurate(III) hydrate (HAuCl₄), copper(II) chloride (CuCl₂), OLA, and ethanol were purchased from Sigma-Aldrich. All reagents were analytical grade and were used for the synthesis without any further purification. ITO coated microscope slides were purchased from Delta Technologies. In a 20 mL glass vial, 7 mL of OLA was combined with 50 μL of HAuCl4 (100 mM) dissolved in ethanol with stirring by vortex and placed on a hot plate. Then, the temperature was increased to 120° C. The color of the solution changed gradually from pale yellow to light pink and then to wine red, the final color. The wine red color indicates the formation of small Au seeds. The solution was then allowed to cool to room temperature.

In a 20 mL glass vial, 5 mL of OLA and 2 mL of Au seeds were mixed at room temperature. Then, 75 μL of HAuCl₄ (100 mM in ethanol) and 50 μL of CuCl₂ (100 mM in ethanol) were sequentially injected into the mixture and heated to 120° C. for 10 min. When the color of the solution changed to green-blue, the solution was removed from the heat source and naturally cooled to room temperature to form concave pentagonal plasmonic particles. In a 20 mL glass vial at room temperature, a growth solution was prepared by adding 600 μL of CuCl₂ (100 mM in ethanol) and 200 μL of HAuCl₄ (100 mM in ethanol) to 7 mL of OLA. Subsequently, 400 μL of freshly prepared concave pentagonal plasmonic particles were added to the mixture (these particles were produced the same day). The solution was heated at 120° C. for 30 min and then cooled at room temperature form the plasmonic particles. The color of the solution at this last step was brown-green. To follow the growth evolution of the plasmonic particles, aliquots were taken from the solution in 10 min intervals during the reaction. The plasmonic particles were further purified by centrifuging several times with ethanol and finally redispersed in chloroform.

Scanning electron microscopy (SEM), scanning transmission electron microscopy (STEM), and energy dispersive spectroscopy (EDS) of the plasmonic particles were performed on a Hitachi 5500 high-resolution microscope operating at 30 kV, equipped with bright-field and annular dark-field detectors, and a Bruker Quantax 200 EDS system. High-resolution transmission electron microscopy was conducted with a JEOL 2010F microscope. Aberration-corrected STEM imaging in high-angle annular dark-field mode was performed on a JEOL ARM200F microscope, operating at 200 kV. The semi angle of collection for HAADF imaging was set to 68-280 mrad, avoiding the contribution of diffraction contrast. The Gatan digital micrograph tomography reconstruction software was used to build the 3D volume of the particles. The 3D simultaneous iterative reconstruction technique algorithm was chosen for the calculations, which improves the signal-to-noise ratio of the reconstructions.103,104 Extinction measurements in solution were collected on a UV-vis Evolution 220 spectrometer.

For the preparation of single-particle samples, a diluted solution of plasmonic particles was spin-coated on ITO-coated glass substrates (15 s at 500 rpm followed by 60 s at 1500 rpm). The density of plasmonic particles on the substrate was optimized by varying the particle concentration. ITO glass slides were cleaned in the following order: washed with Millipore filtered deionized water, ethanol, and acetone by sonication for 10 min. They were then dried with nitrogen gas and oxygen-plasma cleaned for 1 min. The ITO glass was patterned through Au evaporation with an indexed TEM grid acting as a mask for the correlation of NPs between optical and electron microscopies. Scattering spectra were collected using a home-built dark-field microscope based on an inverted microscope body (Zeiss AxioObserver m1) with a hyperspectral detection system previously described. Unpolarized light generated from a tungsten-halogen lamp was focused onto the samples on indexed ITO glass substrates using a dark-field oil-immersion condenser (Zeiss, numerical aperture (NA)=1.4) to create a total internal reflection excitation condition. The scattered light was collected with a 50× air-space objective lens (Zeiss, NA=0.8) and passed to a hyperspectral detection system consisting of an imaging spectrograph with a slit aperture (Princeton Instrument, Acton SpectraPro 2150i with a Pixis 400 thermoelectrically cooled back-illuminated CCD camera) mounted on a computer controlled translation stage (Newport Linear Actuator model LTAHL). Correlated SEM images were collected on a Helios SEM using an electron beam energy of 10 kV.

The plasmonic particles thus obtained had a star-shape including five arms, each arm having a length of 75-90 nm from the center of the star and a width of 10-20 nm as shown in FIG. 4. The five arms were arranged symmetrically with an angle between any two arms of 70-75 degrees. The plasmonic particles displayed light absorption from 710-730 nm by UV-vis spectroscopy and were tuned to tuned for a 785 nm laser light source.

### Example 3

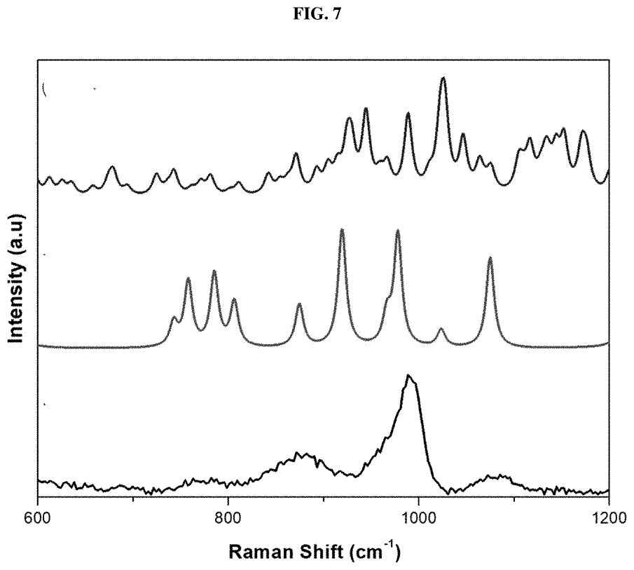

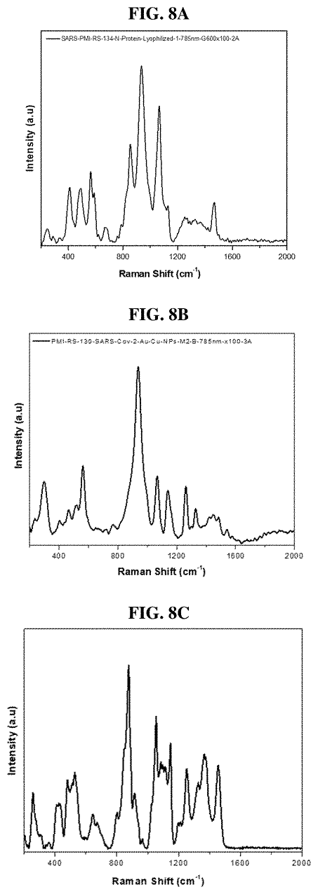

The plasmonic particles were mixed with a solution of the SARS-CoV-2 virion particle. In some cases, CAGE ionic liquid was added to the resultant solution to increase dispersion of the plasmonic particles. The Raman spectra was obtained using a Horiba Xplora 100 spectrometer using 785 nm laser light source. Fluorescence and noise were eliminated using the Lab Spec software from Horiba. Peaks which were not present in all spectra were eliminated. A total of 50 individual spectra were combined and averaged and processed for deconvolution with the Fit-y-k program version 1.3 which offers an alternative of bell-shaped functions to fit the Raman bands. The SM-SERS spectra of the SARS-CoV-2 virion particle is shown in FIG. 7A

The choice of fitting function does not alter the wavenumber position of a given band, but it results in slightly different full-widths at half maximum (FWHM), or line broadenings. Before the fitting was performed, the base line of the Raman spectra was chosen carefully by determining the fluorescence background by fitting a polynomial curve to the measured spectrum from the points where no Raman signal is expected to be present. The polynomial was then subtracted from the original data. The fit was covered to include all spectral details between 400 cm⁻¹ and 1800 cm⁻¹. The fitted data (i.e., Raman signature) of the SARS-CoV-2 virion particle is shown in Table 1.

### Example 4

The procedure of Example 3 was repeated using a solution of the nucleotide protein of SARS-CoV-2 in place of the solution of the SARS-CoV-2 virion particle. The Raman spectra of the nucleotide protein of SARS-CoV-2 is shown in FIG. 7B. The fitted data (i.e., Raman signature) of the nucleotide protein of SARS-CoV-2 is shown in Table 1. Asterisks indicate peaks for which a peak with a corresponding wavenumber value was also observed in the spectrum of the SARS-CoV-2 virion particle. Raman peaks of the nucleotide protein of SARS-CoV-2 at 1050 cm⁻¹, 1248.6 cm⁻¹, 1320.7 cm⁻¹, 1390.0 cm⁻¹, and 1458.1 cm⁻¹ were also observed in the spectrum of the SARS-CoV-2 virion particle.

### Example 5

The procedure of Example 3 was repeated using a solution of the spike protein of SARS-CoV-2 in place of the solution of the SARS-CoV-2 virion particle. The Raman spectra of the spike protein of SARS-CoV-2 is shown in FIG. 7C. The fitted data (i.e., Raman signature) of the spike protein of SARS-CoV-2 is shown in Table 1. Asterisks indicate peaks for which a peak with a corresponding wavenumber value was also observed in the spectrum of the SARS-CoV-2 virion particle. Raman peaks of the spike protein of SARS-CoV-2 at 511.0 cm⁻¹, 716.5 cm⁻¹, 891.9 cm⁻¹, 920.3 cm⁻¹, 1050.2 cm⁻¹, 1128.0 cm⁻¹, 1150.2 cm⁻¹, 1250.7 cm⁻¹, 1320.0 cm⁻¹, and 1449.9 cm⁻¹ were also observed in the spectrum of the SARS-CoV-2 virion particle.

TABLE 1

| SARS-CoV-2 | | SARS-CoV-2 | | SARS-CoV-2 | |
|---|---|---|---|---|---|
| Virion Particle | | Spike Protein | | Nucleotide Protein | |
| Shift | | Shift | | Shift | |
| cm⁻¹ | Assignation | cm⁻¹ | Assignation | cm⁻¹ | Assignation |
| 501.5 | S—S bond (β-Sheet) | 410.5 | Tryptophan or Histidine | 373.8 | δ C—C Aliphatic Chains |
| 531.67 | S—S bond (α-Helix) | 432 | 1-Tyr | 419.6 | Tryptophan or Histidine |
| 577.0 | Trp, Cys | 442.6 | Glucose | 495.2 | S—S bond (β-Sheet) |
| 656.2 | Tyr (α-Helix) | 478.0 | N-Acetyl Glucosamine | 602.1 | Phe |
| 716.7 | Phospholipids | 498.9 | S—S bond (α/β) | 654.5 | Tyr (α-Helix) |
| 782.5 | Histidine | 511.0* | Phosphorylated | 678.4 | Trp |
| | | | protein and lipids | | |
| 846.5 | Tyr doublet | 528.7 | S—S bond (α Helix) | 729.8 | ν-C—C Aliphatic Chains |
| 902.3 | C—O—C Skeletal modes | 545.5 | S—S bond (β-Sheet) | 783.46 | Histidine |
| 951.5 | Trp | 601.0 | Phe | 823.8 | Tyr |
| 983.7 | Trp-Val | 633.8 | Trp | 852.4 | Tyr doublet |
| 1060.3 | Phe | 651.7 | Tyr (α-helix) | 862 | β-Sheet Tyr |
| 1121 | Trp, Phe | 678.4 | Trp | 922.3 | Val-N—Cα-C |
| 1150 | C—N, Glycogen | 716.5* | Phospholipids | 975.8 | Trp, Val |
| 1207 | Phe, Tyr | 786.0 | Histidine | 1050.0* | C—N and C—C |
| | | | | | stretching |
| 1263 | Amide III | 801.1 | Trp | 1076.7 | ν-C—C |
| | | | | | aliphatic chains |
| 1297.4 | Amide III | 849.0 | Tyr doublet | 1107.8 | Histidine, Trp |
| 1340.4 | Trp, C—H deformation | 875.8 | Tryptophan | 1219.3 | Phe, ν-C—C |
| | | | | | aliphatic chains |
| 1378 | L-Alanine, N-Acetyl-Glucosamina | 891.9* | Mono and disaccharides | 1248.6* | Secondary Amid bands |
| | | | C—O—C skeletal modes | | |
| 1445.1 | C—H Deformation | 920.3* | Glucose/glycogen | 1266.9 | Amide III |
| 1492.1 | L-Histidine | 1033.1 | Phe | 1320.7* | Amide III (α-helix |
| | | | | | structures) |
| 1554.0 | Indole ring, Trp | 1050.2* | C—N and C—C | 1390.0* | C—H rocking in lipids |
| | | | protein stretching | | |
| 1626.7 | Tyr, Phe, Trp | 1081.0 | Histidine | 1458.1* | General fatty acids, |
| | | | | | C—H stretching of |
| | | | | | glycoproteins |
| | | 1100.2 | Trp, galactosamine | 1517.4 | Galactosamina, |
| | | | | | Aromatic rings |
| | | 1115.6 | ν-C—C Aliphatic | 1554.9 | Indole ring Trp |
| | | 1128.0* | Trp, Phe | 1608.0 | Trp, Tyr, Phe |
| | | 1150.2* | Glycogen | 1671.7 | Amide I |
| | | 1220.1 | Phe | | |
| | | 1250.7* | Amide III | | |
| | | 1270.7 | α-Helix Amid III | | |
| | | 1305.9 | Phe | | |
| | | 1320.0* | Amide III (α-helix structures) | | |
| | | 1356.7 | Trp, Cα-H deformation | | |
| | | 1383.9 | C—H rocking in lipids | | |
| | | 1449.8* | fatty acids, C—H | | |
| | | | stretching of glycoproteins | | |
| | | 1463.7 | C—H deformation | | |

### Example 6

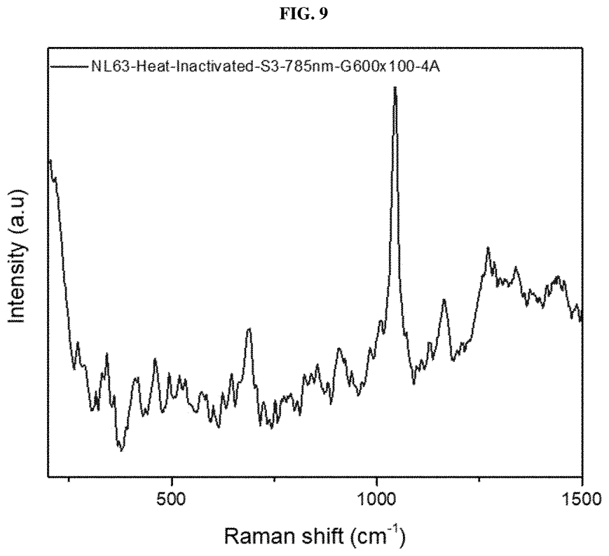

The procedure of Example 3 was repeated using a solution of the human coronavirus HCoV-N163 virion particle in place of the solution of the SARS-CoV-2 virion particle. The Raman spectra of the HCoV-N163 virion particle is shown in FIG. 9. The fitted data (i.e., Raman signature) of the HCoV-N163 virion particle is shown in Table 2.

TABLE 2
HCoV-N163 Virion Particle

| Shift cm ¹ | Assignation |
|---|---|
| 557.92 | S—S bond (β-Sheet) |
| 626.86 | Try |
| 644.00 | Tyr (α-Helix) |
| 656.50 | Try (β-Sheet) |
| 684.82 | ν-C—C aliphatic chains |
| 740.93 | Try (β-Sheet) |
| 759.64 | Trp (β-Sheet) |
| 784.18 | Histidine |
| 825.18 | Tyr (α-Helix) |
| 854.34 | Tyr (β-Sheet) |
| 920.42 | Glucose/glycogen |
| 962.20 | Trp, Val (α-Helix) |
| 1005.04 | Phe ring modes |
| 1026.20 | Phe |
| 1071.08 | ν-C—C aliphatic |
| | chains |
| 1101.00 | Trp, Val |
| 1129.43 | Phe, Trp |
| 1156.12 | C-N, Glycogen |
| 1198.06 | ν-C—C aliphatic chains, Tyr |
| 1231.14 | Amide III (β-Sheet) |
| 1268.94 | Amide III (α-Helix) |
| 1313.23 | Trp, Cα-H deformation |
| 1323.71 | Amide III (α-helix structures) |
| 1340.92 | α/β Trp, Cα-H deformation |
| 1368.81 | N-Acetyl-Glucosamine |
| 1395.94 | C—H rocking in lipids |
| 1446.42 | General fatty acids, |
| | C—H stretching of |
| | glycoproteins |
| 1454.92 | General fatty acids, |
| | C—H stretching of |
| | glycoproteins |
| 1520.56 | Galactosamine, Aromatic rings |
| 1549.18 | Indole ring Trp |

What is claimed is:

1. A diagnostic test to determine the presence of a biological threat, comprising:
a substrate further comprising one or more plasmonic particles; and
a surface-enhanced Raman spectrometer.

2. The diagnostic test of claim 1, wherein the plasmonic particles comprise a metal selected from the group consisting of copper, silver, gold, and a combination thereof.

3. The diagnostic test of claim 1, wherein the substrate comprises molybdenum disulfide.

4. The diagnostic test of claim 1, wherein the biological threat is a virus or a bacterial strain.

5. The diagnostic test of claim 1, wherein the biological threat is a coronavirus.

6. The diagnostic test of claim 1, wherein the biological threat is SARS-CoV-2.

7. The diagnostic test of claim 1, wherein the biological threat is a biological weapon of mass destruction.

8. The diagnostic test of claim 7, wherein the biological weapon of mass destruction is an aerosol.

9. A method to detect a biological threat, comprising the steps of:
obtaining a sample suspected of comprising the biological threat, wherein the sample includes one or more plasmonic particles;
applying Raman spectroscopy on the sample to produce a Raman spectrum; and
analyzing the Raman spectrum for one or more signature Raman shifts characteristic of an interaction of the plasmonic particles with the biological threat.

10. The method of claim 9, wherein the signature Raman shifts have a plurality of values from 300 cm⁻¹ to 1800 cm⁻¹.

11. The method of claim 9, wherein the biological threat is a virus or a bacterial strain.

12. The method of claim 9, wherein the biological threat is a bacterial strain, the bacterial strain selected from the group consisting of an Acinetobacter strain, a Bacillus strain, a Brucella strain, a Burkholderia strain, an Enterococcus strain, an Escherichia strain, a Francisella strain, a Klebsiella strain, a Proteus strain, a Serratia strain, a Streptococcus strain, a Staphylococcus strain, a Yersinia strain, and a combination thereof.

13. The method of claim 9, wherein the biological threat is a coronavirus.

14. The method of claim 9, wherein the biological threat is SARS-CoV-2.

15. The method of claim 9, wherein the biological threat is a biological weapon of mass destruction.

16. The method of claim 15, wherein the biological weapon of mass destruction is an aerosol.

17. The method of claim 9, wherein the sample is selected from the group consisting of a patient sample, an environmental sample, or a personal protection equipment.

18. The method of claim 9, wherein the plasmonic particles comprise a metal selected from the group consisting of copper, silver, gold, and a combination thereof.

19. A method for identifying antibiotic resistance in a bacterial strain sample is, the method comprising:
obtaining a bacterial strain sample comprising one or more plasmonic particles;
obtaining a Raman spectroscopy spectrum of the bacterial strain sample; and
analyzing the Raman spectrum for one or more signature Raman shifts characteristic of an interaction of the plasmonic particles with proteins conferring antibiotic resistance.

20. An active personal protection equipment, wherein the active personal protection equipment (active PPE) is capable of interacting with a biological threat, comprising:
a personal protection equipment; and
one or more plasmonic particles embedded on or within the active PPE, wherein the plasmonic particles are present on the surface of the active PPE to interact with the biological threat.

21. The active PPE of claim 20, wherein the active PPE is used to detect the presence of contamination with the biological threat.

22. The active PPE of claim 20, wherein the plasmonic particles comprise a metal selected from the group consisting of copper, silver, gold, and a combination thereof.

23. The active PPE of claim 20, wherein an interaction of the plasmonic particles with the biological threat deactivates the biological threat.

24. The active PPE of claim 20, further comprising a composition of ionic liquids.

25. The active PPE of claim 20, wherein the plasmonic particles and composition of ionic liquids are electrospun for application onto or into the active PPE.

26. A device for detecting a biological threat, the device comprising one or more signature Raman shifts characteristic of an interaction of the plasmonic particles with the biological threat.

27. The device of claim 26, wherein the device is configured to be used with the diagnostic test of claim 1, the method of claim 9, the method of claim 19, and the active personal protection equipment of claim 20.
